(19) United States
(12) Patent Application Publication
(10) Pub. No.: US 2024/0242273 A1
(43) Pub. Date: Jul. 18, 2024

(54) MODEL GENERATION DEVICE, FINANCIAL INSTITUTION SERVER, INFORMATION PROCESSING SYSTEM, MODEL GENERATION METHOD, AND STORAGE MEDIUM

(71) Applicant: NEC Corporation, Minato-ku, Tokyo (JP)

(72) Inventors: Daisuke MATSUDA, Tokyo (JP); Yoshiyuki ETOU, Tokyo (JP); Satoru FUJII, Tokyo (JP); Ryo FURUKAWA, Tokyo (JP); Wataru ITONAGA, Tokyo (JP)

(73) Assignee: NEC Corporation, Minato-ku, Tokyo (JP)

(21) Appl. No.: 18/574,415

(22) PCT Filed: Jul. 2, 2021
(86) PCT No.: PCT/JP2021/025177

§ 371 Date: Dec. 27, 2023

(51) Int. Cl. G06Q 40/02; G06N 20/00

(52) U.S. Cl. CPC G06Q 40/02; G06N 20/00

(57) ABSTRACT

A model generation device according to the present disclosure comprises: an information receiving means that receives input of financial transaction information including customer information which has been anonymized in each of a plurality of financial institution servers; a model generation device that generates a model for analyzing financial transactions using the financial transaction information received from the plurality of financial institution servers; and an outputting means that outputs the model generated by the model generation means.

### TECHNICAL FIELD

The present disclosure relates to a model generation device, a financial institution server, an information processing system, a model generation method, a storage medium, and the like.

### BACKGROUND ART

A bank extracts customers to whom the bank proposes financial products such as investment trusts by using assets, revenues, and asset management statuses of customers (individuals and corporations) held by the bank itself. As a means for extracting customers, an AI model is used. To generate the model, customer information held by each bank is used. In order to improve the performance and accuracy of the model, a technique of performing machine learning while protecting privacy is used.

For example, PTL 1 discloses a computer implementation method including a step of acquiring, by a training broker from each individual data source of a plurality of data sources, anonymized data for training a model, the anonymized data being accessed via a data science schema provided by anonymization of sensitive information of production data from each individual data source, and a step of providing, to a data vendor, access to the anonymized data for training a machine learning model using the anonymized data.

### CITATION LIST

### Patent Literature

PTL 1: JP 2020-187723 A

### SUMMARY OF INVENTION

### Technical Problem

However, PTL 1 described above does not disclose training a model based on financial transaction information held by a plurality of financial institutions. In analysis of a financial transaction, a more accurate model can be generated by using information held by a plurality of financial institutions than by using information held by each financial institution.

An example of an object of the present disclosure is to provide a model regarding analysis of a financial transaction with higher accuracy while considering privacy of a customer of each financial institution.

### Solution to Problem

A model generation device according to an aspect of the present disclosure includes an information receiving means that receives an input of financial transaction information including customer information anonymized in each of a plurality of financial institution servers, a model generation means that generates a model for analyzing a financial transaction, using the financial transaction information received from the plurality of financial institution servers, and an output means that outputs the model generated by the model generation means.

A financial server according to an aspect of the present disclosure includes an information storage means that stores financial transaction information including customer information to be used for analyzing a financial transaction, an anonymization means that anonymizes the customer information in the financial transaction information stored in the information storage means, an input/output means that transmits the financial transaction information to a model generation device in a form in which the customer information is anonymized, and an analysis means that performs analysis regarding the financial transaction, using a model generated based on the financial transaction information including the anonymized customer information stored in a plurality of financial institution servers.

An information processing system according to an aspect of the present disclosure includes a plurality of financial institution servers and a model generation device. Each of the plurality of financial institution servers includes an information storage means that stores financial transaction information including customer information, an anonymization means that anonymizes the customer information in the financial transaction information stored in the information storage means, and an input/output means that transmits the customer information in the financial transaction information to the model generation device in an anonymized form. The model generation device includes an information receiving means that receives an input of the financial transaction information including the customer information anonymized in each of the plurality of financial institution servers, a model generation means that generates a model for analyzing a financial transaction, using the financial transaction information received from the plurality of financial institution servers, and an output means that outputs the model generated by the model generation means.

A model generation method according to an aspect of the present disclosure includes receiving an input of financial transaction information including customer information anonymized in each of a plurality of financial institution servers, generating a model for analyzing a financial transaction, using the financial transaction information received from the plurality of financial institution servers, and outputting the generated model.

A storage medium according to an aspect of the present disclosure stores a program for causing a computer to execute receiving an input of financial transaction information including customer information anonymized in each of a plurality of financial institution servers, generating a model for analyzing a financial transaction using the financial transaction information received from the plurality of financial institution servers, and outputting the generated model.

### Advantageous Effects of Invention

An example of an effect of the present disclosure is to provide a model regarding analysis of a financial transaction with higher accuracy while considering privacy of a customer of each financial institution.

### BRIEF DESCRIPTION OF DRAWINGS

FIG. 1 is a block diagram illustrating a configuration of an information processing system according to a first example embodiment.

FIG. 2 is a diagram illustrating a hardware configuration in which a model generation device according to the first example embodiment is implemented by a computer device and its peripheral device.

FIG. 3 is a diagram illustrating an example of financial transaction information including anonymized customer information according to the first example embodiment.

FIG. 4 is a flowchart illustrating an operation of generating a model according to the first example embodiment.

FIG. 5 is a block diagram illustrating a configuration of an information processing system according to a second example embodiment.

FIG. 6 is a flowchart illustrating an operation of information processing according to the second example embodiment.

### EXAMPLE EMBODIMENTS

Example embodiments will be described in detail with reference to the drawings.

### First Example Embodiment

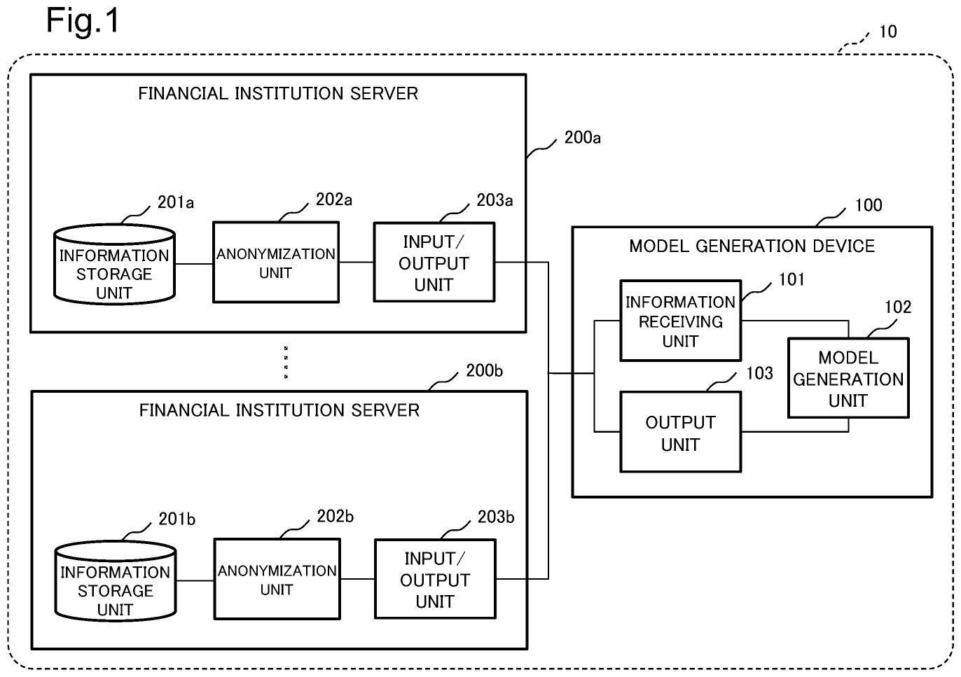

FIG. 1 is a block diagram illustrating a configuration of an information processing system 10 according to a first example embodiment. The information processing system 10 according to the first example embodiment is a system for generating a model for analysis using financial transaction information including customer information held by a plurality of financial institutions. The analysis of a financial transaction in the present example embodiment is, for example, analysis for a financial institution to advise a customer on a financial transaction. The financial institutions include a credit card company and a settlement business operator that handles cashless payment in addition to business operators that handle financial products, such as banks (including city banks, Japan Post Bank, regional banks, credit associations, and credit associations), a securities company, or an insurance company. As a financial institution in the first example embodiment, an article lessor that performs a leasing business or a rental business of automobiles and home electric appliances is also included. Examples of the financial products include a deposit, a bond, an investment trust, a foreign currency, a stock, a future transaction, FX, a virtual currency, and the like.

Referring to FIG. 1, the information processing system 10 includes a model generation device 100 and a plurality of financial institution servers 200 (200a, 200b). The model generation device 100 is implemented by a service provider that provides a financial transaction analysis service tool or the like to each of the financial institutions. The service provider provides a financial transaction analysis service or the like incorporating a model for analyzing a financial transaction generated using anonymized information held by each financial institution. The financial transaction information in the present example embodiment includes personal information of a customer who has conducted a financial transaction such as purchase, lending, deposition, or withdrawal of a financial product in each financial institution, and information of a financial transaction conducted by the customer. The model generation device 100 includes an information receiving unit 101, a model generation unit 102, and an output unit 103. Each of the financial institution servers 200 includes an information storage unit 201 (201a, 201b) that stores customer information and financial transaction information, an anonymization unit 202 (202a, 202b) that anonymizes the customer information, and an input/output unit 203 (203a, 203b) that receives and outputs the customer information from and to the model generation device 100. In the present example embodiment, the plurality of financial institution servers 200 are provided at two locations, but the present invention is not limited thereto. The plurality of financial institution servers 200 are provided as many as the number of financial institutions that provide the financial transaction information to the service provider. The model generation device 100 that is an essential configuration of the present example embodiment will be described in detail.

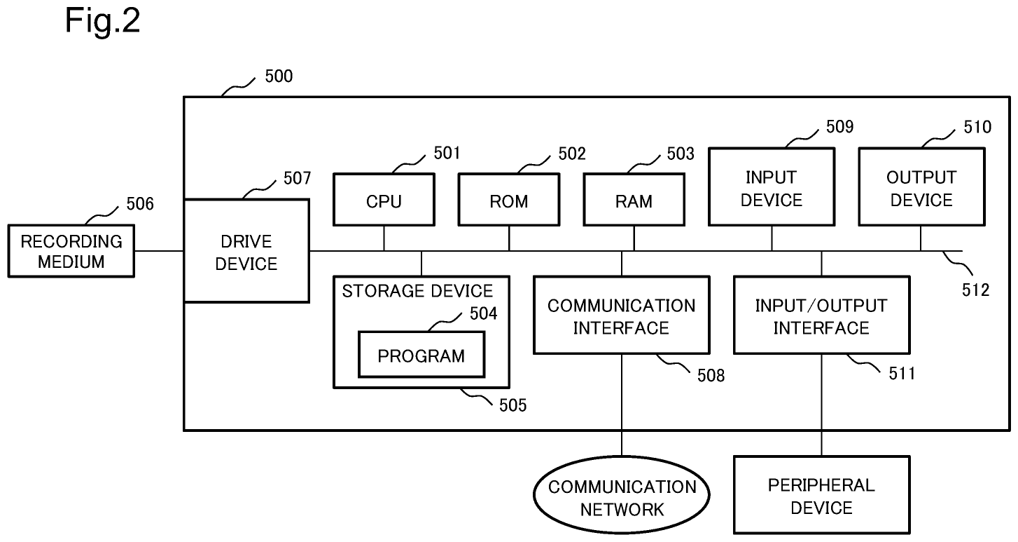

FIG. 2 is a diagram illustrating an example of a hardware configuration in which the model generation device 100 according to the first example embodiment is implemented by a computer device 500 including a processor. As illustrated in FIG. 2, the model generation device 100 includes a central processing unit (CPU) 501, memories such as a read only memory (ROM) 502 and a random access memory (RAM) 503, a storage device 505 that stores a program 504 and is a hard disk or the like, a communication interface (I/F) 508 for network connection, and an input/output interface 511 that receives and outputs data. In the first example embodiment, the financial transaction information received from each financial institution server 200 is input to the model generation device 100 via the communication I/F 508.

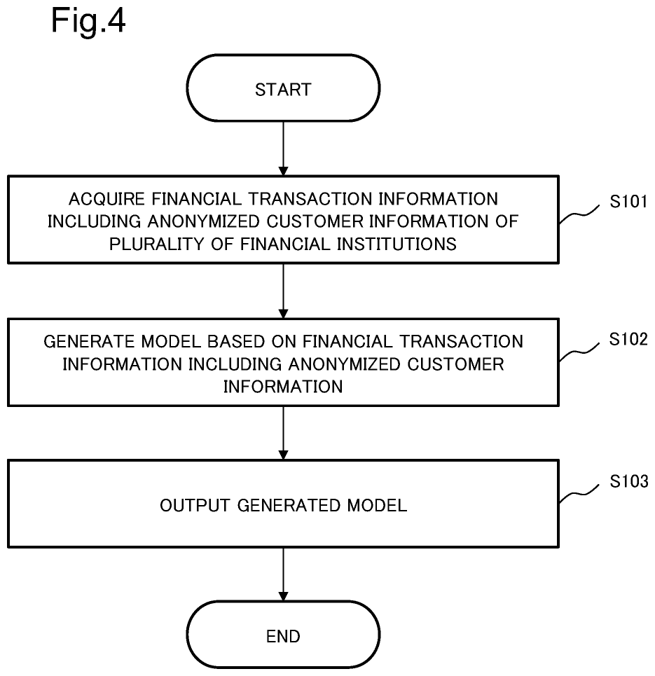

The CPU 501 operates an operating system to control the entire model generation device 100 according to the first example embodiment of the present invention. The CPU 501 reads a program and data from a storage medium 506 mounted on, for example, a drive device 507 to a memory. In addition, the CPU 501 functions as the information receiving unit 101, the model generation unit 102, the output unit 103, and a part of these components in the first example embodiment, and executes processing or a command in a flowchart illustrated in FIG. 4 to be described later based on the program.

The storage medium 506 is, for example, an optical disc, a flexible disk, a magnetic optical disc, an external hard disk, a semiconductor memory, or the like. The storage medium that is a part of the storage device is a nonvolatile storage device, and records the program therein. The program may be downloaded from an external computer (not illustrated) connected to a communication network.

The input device 509 is implemented by, for example, a mouse, a keyboard, a built-in key button, and the like, and is used for an input operation. The input device 509 is not limited to the mouse, the keyboard, and the built-in key button, and may be, for example, a touch panel. The output device 510 is implemented by, for example, a display, and is used to check an output.

As described above, the first example embodiment illustrated in FIG. 1 is implemented by the computer hardware illustrated in FIG. 2. However, the means for implementing each unit included in the model generation device 100 in FIG. 1 are not limited to the configuration described above. The model generation device 100 may be implemented by one physically coupled device, or may be implemented by a plurality of devices that are two or more physically separated devices connected in a wired or wireless manner. For example, the input device 509 and the output device 510 may be connected to the computer device 500 via a network. The model generation device 100 according to the first example embodiment illustrated in FIG. 1 can also be configured by cloud computing or the like.

In FIG. 1, the information receiving unit 101 is a means that receives an input of financial transaction information including customer information anonymized in each of the plurality of financial institution servers. The customer information is information regarding an individual customer, and refers to information that can identify the specific individual by a single or a plurality of combinations, such as a name, an occupation, an age, a revenue, assets held, a date of birth, or the like. Information on the assets held includes financial assets such as cash, a deposit, and a saving, or securities (investment trusts/stocks/government bonds/bonds), real estate (the state of a lien), and movable property. The customer information also includes information such as revenue and expenditure information other than assets. In a case where the customer is an individual, the revenue and expenditure information includes annual income, a loan, deposit and withdrawal of an account, use of an automatic teller machine, and the like. In a case where the customer is a corporation, the revenue and expenditure information includes information obtained from a balance sheet, a profit and loss balance sheet, a cash flow, or the like. In the case of a corporation, in addition to the revenue and expenditure information, information such as business relationships, stock relationships (major shareholders, etc.), a transaction bank, an industry ranking/share, a rating, or a corporate history is also included as the customer information. The anonymized customer information refers to processing of converting the customer information in such a way that a specific customer cannot be identified. Specific methods of the anonymization include, but are not limited to, K anonymization in which data is processed in such a way that K or more pieces of data having the same attribute are present in target data, I diversity in which data is processed in such a way that the number of data attributes is I or more, t approximation in which data is processed in such a way that a deviation in a data distribution is reduced, and difference privacy in which data is processed in such a way that learning can be performed while individuals are not identified.

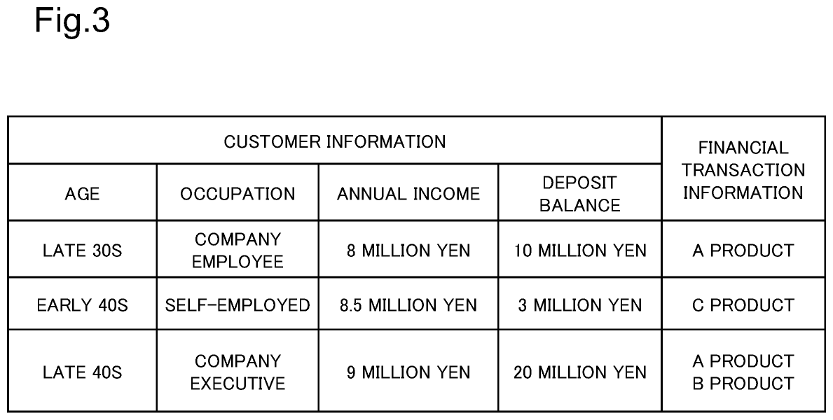

FIG. 3 is a diagram illustrating an example of the financial transaction information including the anonymized customer information. In the present example embodiment, as illustrated in FIG. 3, information such as a name and an address that can independently identify an individual customer is not included. Information regarding age, occupation, or family structure that is necessary for analysis of a financial transaction and that may lead to identification of an individual is abstracted and used, for example. On the other hand, information regarding annual income, deposit balance, and transaction results that are necessary for analysis of a financial transaction as they are is used as it is. The example of the financial transaction information illustrated in FIG. 3 is an example, and the anonymized customer information of the present example embodiment is not limited thereto. The customer information to be anonymized may be changed depending on the degree of confidentiality of the financial transaction information. The same applies to a case where the customer is a corporation.

For example, the information receiving unit 101 receives and accepts financial transaction information including anonymized customer information from the plurality of financial institution servers 200 via a network and the communication I/F 508 when an operation for generating a model is performed by the service provider. The information receiving unit 101 outputs the received financial transaction information to the model generation unit 102 in a form in which the customer information is anonymized.

The model generation unit 102 is a means that generates a model for analyzing a financial transaction by using the financial transaction information received by the information receiving unit 101 and including the anonymized customer information held by the plurality of financial institutions. In this model, in the learning process, a trained model indicating a relationship between one or more types of customer information acquired as learning data and financial transaction information of the customer indicating a correct answer label of the learning data is generated using, for example, a neural network, graph AI, or another machine learning algorithm.

Next, in an estimation process, the model generation unit 102 inputs specific customer information to the trained model and estimates a financial transaction that can be conducted. As described above, the model is trained using the learning data, and the content of the financial transaction that can be conducted is specified. The model is, for example, a model that outputs, upon receiving information regarding an asset of a customer, a financial product or a financial transaction recommended to the customer or credit information (credit line) of the customer. The model generation unit 102 outputs the model thus obtained to the output unit 103.

The output unit 103 is a means that transmits the model generated by the model generation unit 102 for analysis of a financial transaction to the financial institution servers 200. The output unit 103 transmits the model in such a format that the financial institution servers 200 can analyze a financial transaction, using the model. The output unit 103 may transmit the model in a format in which a financial transaction can be analyzed using the model on the financial institution server 200 side, and may transmit the model in a concealed format.

The operation of the model generation device 100 configured as described above will be described with reference to the flowchart of FIG. 4.

FIG. 4 is a flowchart illustrating an outline of the operation of the model generation device 100 according to a second example embodiment. A process according to this flowchart may be executed based on program control by the processor described above.

As illustrated in FIG. 4, first, the information receiving unit 101 acquires financial transaction information including anonymized customer information held by the plurality of financial institutions in each of the plurality of financial institution servers (step S101). Next, the model generation unit 102 generates a model for analyzing a financial transaction by using the acquired financial transaction information including the anonymized customer information (step S102). Finally, the output unit 103 outputs the model generated by the model generation unit 102 (step S103). As described above, the model generation device 100 ends the model generation operation.

In the model generation device 100, the model generation unit 102 generates a model for analyzing a financial transaction by using financial transaction information including anonymized customer information held by a plurality of financial institutions. As a result, it is possible to provide a model regarding analysis of a financial transaction with higher accuracy while considering privacy of each customer of each financial institution.

### Second Example Embodiment

Next, a second example embodiment of the present disclosure will be described in detail with reference to the drawings. Hereinafter, description of contents overlapping with the above description will be omitted to the extent that the description of the present example embodiment is not unclear. An information processing system 11 according to the second example embodiment is used to provide models generated by using financial transaction information held by a plurality of financial institutions. These models are incorporated into, for example, an analysis tool for setting (loan examination) advice regarding financial transactions for customers and credit information of customers. The advice regarding the financial transactions also includes advice regarding financial management strategies and financial product transactions for corporations, and examples of the advice include M&A support or recommendation of financial products/services. These models are also used to advise whether the content of a particular financial transaction is fraudulent. The types of the models in the present example embodiment vary depending on the application to be analyzed, and may be models associated to the types of financial institutions, the business contents of the financial institutions, or customer segments. Here, the customer segments are classified into a corporation industry type, a listed company (first section of the Tokyo Stock Exchange, second section, Mothers), an unlisted company, a business scale (capital stock, number of employees), and the like. For example, in the case of a regional bank, it is considered that customers include a corporation having a trading area in a local area, and thus, a model for analyzing financial transactions having characteristics in the trading area and business scale in the local area is provided. Similarly to the computer device illustrated in FIG. 2, each component in each example embodiment of the present disclosure can be implemented not only by hardware but also by a computer device based on program control and firmware.

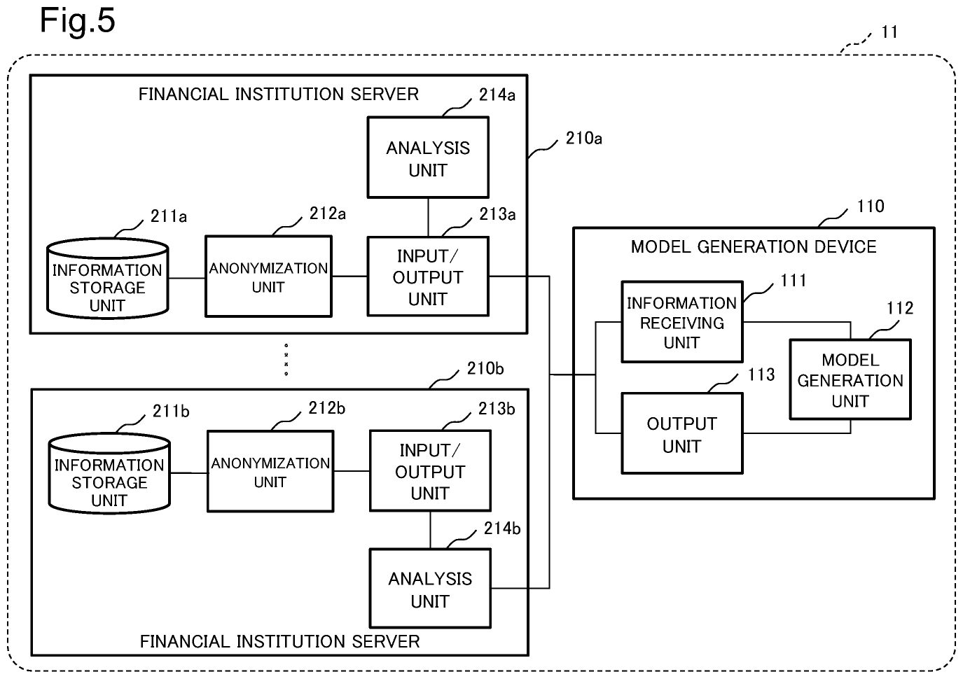

FIG. 5 is a block diagram illustrating a configuration of the information processing system 11 including a model generation device 110 according to the second example embodiment of the present disclosure. With reference to FIG. 5, the model generation device 110 and financial institution servers 210 (210a, 210b) according to the second example embodiment will be described focusing on parts different from those of the information processing system 10 according to the first example embodiment. The model generation device 110 according to the second example embodiment includes an information receiving unit 111, a model generation unit 112, and an output unit 113. The plurality of financial institution servers 210 (210a, 210b) include information storage units 211 (211a, 211b), anonymization units 212 (212a, 212b), input/output units 213 (213a, 213b), and analysis units 214 (214a, 214b). The model generation device 110 generates a model for analyzing a financial transaction for a corporation by using anonymized customer information received from the plurality of financial institution servers 210a and 210b.

Here, details of each model used in a financial transaction analysis tool for corporations will be described. A model for M&A support includes a model used by an acquirer and a model used by a seller (non-acquirer). The acquisition-side model is, for example, a model obtained by learning an industry type, sales, a region, or the like as learning data based on past success examples, and this model receives a name of a company that desires acquisition, and outputs information indicating whether the acquisition is possible or the acquisition amount. The seller-side model is, for example, a model obtained by learning an industry type, sales, a region, or the like as learning data based on past success examples. This model receives a name of a company that is a desired acquirer, and outputs a possibility that the company desires acquisition and a desired expected acquisition amount. By using a model trained from customer information held by the plurality of financial institutions, matching between an acquirer and a seller can be made accurate, and loan opportunities can be increased.

For example, the model for loan examination receives, as an input value, a repayment status of a company as an existing customer and outputs a loan amount (increase amount, refinancing, extension of a period). By using the model trained from the customer information held by the plurality of financial institutions, it is possible to facilitate determination of loan and examination businesses and improve the efficiency of the businesses. The model for recommendation of a product/service receives customer information and transaction information for a predetermined past period, and outputs a financial product or financial products recommended to a customer. In addition, as an example of another model, contents such as a type of a financial product and a purchase cost of the financial product are input, and a customer or customers who are predicted to purchase the financial product or the like are output. In this case, the model is not limited to a customer or customers predicted to purchase an individual financial product, and may output a customer or customers predicted to purchase a combination of a plurality of financial products. In addition, the model may also output a possibility that a customer actually purchases a financial product or the like as output from the model and sales negotiation is established. By generating the model using the customer information held by the plurality of financial institutions, it is possible to output a more accurate analysis result even for a model for recommending a complicated financial product/service, and to increase loan opportunities.

For example, a fraudulent transaction detection model receives the content of a financial transaction such as remittance by a customer, and outputs whether it corresponds to detection of a fraudulent act such as money laundering (anti-money laundering). The money laundering includes unnatural transactions, fraudulent account transactions such as transfer fraud, anti-social forces, terrorism funds, and loan fraud. This model is generated by learning, as teacher data, data of cases actually referred to by a person in charge to determine whether money laundering has occurred for a transaction status in a past certain period of time. By generating the model using the financial transaction information held by the plurality of financial institutions, it is possible to output a more accurate analysis result and to suppress fraudulent transactions.

### <Model Generation Device>

The model generation unit 112 receives the financial transaction information held by each financial institution from the financial institution servers 210 through the communication I/F 508 in a form in which the customer information is anonymized. Next, the model generation unit 112 generates an analysis model for a financial transaction, using the financial transaction information including the received anonymized customer information, and outputs the generated model to the output unit 113. The output unit 113 transmits the generated model to each of the financial institution servers 210 through the input/output unit 213. In addition, after the transmission of the model to the financial institution servers 210, when the financial institution servers 210 cause the model to learn again and the model is updated, the model generation device 110 may receive the updated model again. In addition, the model generation device 110 may receive financial transaction information including anonymized customer information additionally obtained from the financial institution servers 210 and perform learning again. Furthermore, the model generation unit 112 may update and improve the model by verifying the trained model based on a result of a financial transaction attempted based on an analysis result by the model in a financial institution. Note that the operations of the information receiving unit 111, the model generation unit 112, and the output unit 113 are similar to the operations of the information receiving unit 101, the model generation unit 102, and the output unit 103 in the first example embodiment, and thus, description thereof is omitted here.

### <Financial Institution Servers>

In each of the financial institution servers 210, the analysis unit 214 performs analysis using the model received from the model generation device 110. The generated model is incorporated into, for example, a tool for analyzing financial transactions for corporations in the financial institutions. The analysis unit 214 performs analysis regarding M&A using the generated model when an operation on an analysis tool for a financial transaction is performed by the user, and outputs an analysis result in a state where the analysis result can be viewed on a display device or the like. For example, in a tool using a model on the acquisition side, the analysis unit 214 receives an input of a name of a company desired to be acquired, and outputs information indicating whether the acquisition is possible or the acquisition amount. For example, in a tool using a seller side model, the analysis unit 214 receives an input of a name of a company that is a desired acquirer, and outputs a possibility that the company that is a desired acquirer desires acquisition and a desired expected acquisition amount. In order to improve the accuracy of the analysis result by the analysis unit 214, the financial institution servers 210 may perform learning again based on the additionally obtained customer information and financial transaction information, and transmit the updated model to the model generation device 110. Alternatively, the financial transaction information with the concealed customer information may be additionally transmitted to the model generation device 110, and learning may be performed again on the model generation device 110 side. By repeating the update of the model by learning in each financial institution server 210 or the model generation device 110, for example, until a predetermined condition is satisfied, the accuracy of the model can be further improved. The predetermined condition is stored in the storage device 505, for example.

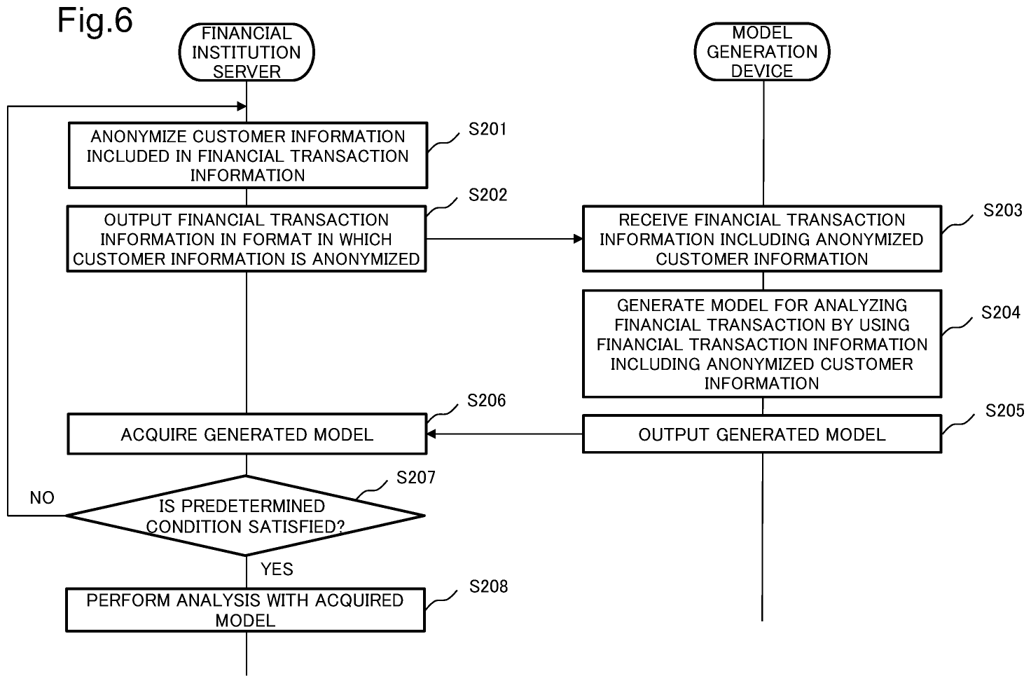

An operation of the information processing system 11 configured as described above will be described with reference to the flowchart of FIG. 6.

FIG. 6 is a flowchart illustrating an outline of the operation of the information processing system 11 according to the first example embodiment. A process according to this flowchart may be executed based on program control by the processor described above.

As illustrated in FIG. 6, first, the anonymization units 212 in the financial institution servers 210 anonymize customer information included in financial transaction information stored in the information storage units 211 (step S201). Next, the input/output units 213 output the financial transaction information to the model generation device 110 in a format in which the customer information is anonymized (step S202). Next, the information receiving unit 111 of the model generation device 110 receives the financial transaction information including the anonymized customer information (step S203). Next, the model generation unit 112 generates a model for analyzing a financial transaction by using the financial transaction information including the anonymized customer information held by the plurality of financial institutions (step S204). Next, the output unit 113 outputs the model generated by the model generation unit 112 to each of the financial institution servers 210 (step S205). Next, the financial institution servers 210 acquire the model generated through the input/output units 213 (step S206). Next, the financial institution servers 210 determine whether a predetermined condition is satisfied (step S207). In a case where the predetermined condition is satisfied (step S207; YES), the analysis units 214 perform analysis using the generated model, and end the flow (step S208). In a case where the predetermined condition is not satisfied, the financial institution servers 210 return to step S201 (step S207; NO) and perform the flow again. Thus, the information processing system 11 ends the operation of information processing.

In the second example embodiment of the present disclosure, a more accurate analysis result can be output by using a model generated using information held by a plurality of financial institutions for a tool for assisting corporations.

### Modifications of Second Example Embodiment

The information processing system 11 in the second example embodiment can also be used in a system for assisting individuals in a financial institution. Examples of the model to be generated by the model generation device 110 include loan examination, purchase prediction, cancellation prediction, and the like. A model for loan examination receives a customer attribute and a repayment status as input values and outputs an amount to be loaned. The purchase prediction is to receive a status of a transaction for a certain past period as an input value, and output a determination as to whether to recommend a financial product of a financial institution or a determination as to which financial product to recommend. The cancellation prediction is to receive a status of a transaction of each financial institution for a predetermined past period as an input value, and output a result obtained by scoring the possibility of early repayment of a loan and the possibility of time deposit cancellation/account cancellation for each customer of the financial institutions.

In addition, the information processing system 11 can also use a model related to human resources (evaluation/appropriateness/transfer) of a financial institution. The model for human resources is used to determine a separation probability, a promotion probability, necessity of transfer, a transfer destination, and the like of an employee based on human resources information of the employee in a certain past period. By using the highly accurate model generated by using the information held by the plurality of financial institutions, it is possible to reduce the time for making a determination and improve business efficiency.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, although the plurality of operations is described in order in the form of the flowcharts, the order of the description does not limit the order of executing the plurality of operations. Therefore, when each example embodiment is implemented, the order of the plurality of operations can be changed as long as the change does not affect the content.

In addition, in the present example embodiment, the plurality of financial institutions is not limited to financial institutions of the same business type, and may include a bank and a financial institution other than a bank, such as a bank and a securities company or an insurance company. Even when a plurality of financial institutions is constituted by banks, the financial institutions may be constituted by banks having different scales, such as city banks and regional banks.

### REFERENCE SIGNS LIST

10, 11 information processing system
100, 110 model generation device
101, 111 information receiving unit
102, 112 model generation unit
103, 113 output unit
200, 210 financial institution server
201, 211 information storage unit
202, 212 anonymization unit
203, 213 input/output unit
214 analysis unit

What is claimed is:

1. A model generation device comprising:
a memory storing instructions; and
at least one processor configured to execute the instructions to:
receive an input of financial transaction information including customer information anonymized in each of a plurality of financial institution servers;
generate a model for analyzing a financial transaction, using the financial transaction information received from the plurality of financial institution servers; and
output the model generated.

2. The model generation device according to claim 1, wherein the at least one processor is further configured to execute the instructions to:
generate a model that receives an input of desired M&A partner information and outputs information indicating whether acquisition is possible or an expected acquisition amount.

3. The model generation device according to claim 1, wherein the at least one processor is further configured to execute the instructions to:
generate a model that receives information regarding an asset of a customer and outputs credit information of the customer.

4. The model generation device according to claim 1, wherein the at least one processor is further configured to execute the instructions to:
generate a model that receives a content of a specific financial transaction and outputs information indicating whether the financial transaction is fraudulent or not.

5. A financial institution server comprising:
a memory storing instructions; and
at least one processor configured to execute the instructions to:
store financial transaction information including customer information to be used for analyzing a financial transaction;
anonymize the customer information in the financial transaction information stored;
transmit the financial transaction information to a model generation device in a form in which the customer information is anonymized; and
perform analysis regarding the financial transaction, using a model generated based on anonymized financial transaction information stored in a plurality of financial institution servers.

6. The financial institution server according to claim 5, wherein the at least one processor is further configured to execute the instructions to:
perform analysis regarding M&A using a model generated based on financial transaction information regarding a past M&A case stored in a plurality of financial institution servers.

7. The financial institution server according to claim 5, wherein the at least one processor is further configured to execute the instructions to:
perform analysis regarding whether a financial transaction is fraudulent by using a model generated, based on financial transaction information stored in a plurality of financial institution servers and previously determined to be fraudulent.

8. An information processing system including a plurality of financial institution servers and a model generation device, wherein
each of the plurality of financial institution servers comprising:
a memory storing instructions; and
at least one processor configured to execute the instructions to:
store financial transaction information including customer information,
anonymize the customer information in the financial transaction information stored, and
transmit the financial transaction information to the model generation device in a form in which the customer information is anonymized, and
the model generation device comprising:
a memory storing instructions; and
at least one processor configured to execute the instructions to:
receive an input of the financial transaction information including the customer information anonymized in each of the plurality of financial institution servers,
generate a model for analyzing a financial transaction, using the financial transaction information received from the plurality of financial institution servers, and
output the model generated.

9. A model generation method comprising:
receiving an input of financial transaction information including customer information anonymized in each of a plurality of financial institution servers;
generating a model for analyzing a financial transaction, using the financial transaction information received from the plurality of financial institution servers; and
outputting the generated model.

10. (canceled)
